(19) United States
(12) Patent Application Publication
(10) Pub. No.: US 2026/0086856 A1
(43) Pub. Date: Mar. 26, 2026

(54) INFRASTRUCTURE AUTOMATION USING A DYNAMIC DIRECTED ACYCLIC GRAPH

(71) Applicant: EQUIFAX INC., Atlanta, GA (US)

(72) Inventors: Sumeet Wilkhu, Atlanta, GA (US); Michael Teav, Suwanee, GA (US); Mounica Yenugula, Cumming, GA (US)

(73) Assignee: EQUIFAX INC., Atlanta, GA (US)

(21) Appl. No.: 18/898,093

(22) Filed: Sep. 26, 2024

(51) Int. Cl. G06F 9/50

(52) U.S. Cl. CPC G06F 9/5027

(57) ABSTRACT

A system can be used to automatically generate infrastructure using a dynamic DAG. The system can receive an input file that can include indications of computing resources for a cloud computing environment. The system can parse the input file to determine a topology of the computing resources based on indications. The system can generate, based on the topology, a dynamic DAG for generating infrastructure for the cloud computing environment based on the computing resources. Generating the dynamic DAG can include (i) determining a first subset of the computing resources and a second subset of the computing resources, and (ii) configuring the first subset of the computing resources to be processed differently from the second subset of the computing resources.

### TECHNICAL FIELD

The present disclosure relates generally to computing operations and access control. More specifically, but not by way of limitation, this disclosure relates to automatically generating infrastructure for access control using a dynamic directed acyclic graph (DAG).

### BACKGROUND

Cloud computing systems are increasingly used by individuals and organizations alike. Cloud computing systems may provide scalability, data security, enhanced storage and processing capacities, and so on. As with many other systems, whether physical or digital, cloud computing systems may rely on infrastructure to perform requested operations, to create requested resources, etc. Generating infrastructure for cloud computing systems can be difficult. For example, conventional cloud computing systems may rely on manually created or updated infrastructure. Manually creating or updating infrastructure may limit the scalability of cloud computing systems or may otherwise present challenges for cloud computing systems.

### SUMMARY

Various aspects of the present disclosure provide systems and methods for automatically generating or configuring infrastructure based on a dynamic DAG. A system can include a processor and a non-transitory computer-readable medium that can include instructions that are executable by the processor to cause the processor to perform various operations. The system can receive an input file that can include a set of indications of computing resources for a cloud computing environment. The system can parse the input file to determine a topology of the computing resources based on the set of indications. The system can generate, based on the topology, a dynamic directed acyclic graph (DAG) for generating infrastructure for the cloud computing environment based on the computing resources. The operation of generating the dynamic DAG can include (i) determining a first subset of the computing resources and a second subset of the computing resources, and (ii) configuring the first subset of the computing resources to be processed differently from the second subset of the computing resources. The system can provide a responsive message to the input file to control access to the infrastructure.

In other aspects, a method can be used to automatically generate the infrastructure. The method can include receiving an input file that can include a set of indications of computing resources for a cloud computing environment. The method can include parsing the input file to determine a topology of the computing resources based on the set of indications. The method can include generating, based on the topology, a dynamic directed acyclic graph (DAG) for generating infrastructure for the cloud computing environment based on the computing resources. Generating the dynamic DAG can include (i) determining a first subset of the computing resources and a second subset of the computing resources, and (ii) configuring the first subset of the computing resources to be processed differently from the second subset of the computing resources. The method can include providing a responsive message to the input file that controls access to the infrastructure.

In other aspects, a non-transitory computer-readable medium can include instructions that are executable by a processing device for causing the processing device to perform various operations. The operations can include receiving an input file that can include a set of indications of computing resources for a cloud computing environment. The operations can include parsing the input file to determine a topology of the computing resources based on the set of indications. The operations can include generating, based on the topology, a dynamic directed acyclic graph (DAG) for generating infrastructure for the cloud computing environment based on the computing resources. The operation of generating the dynamic DAG can include (i) determining a first subset of the computing resources and a second subset of the computing resources, and (ii) configuring the first subset of the computing resources to be processed differently from the second subset of the computing resources. The operations can include providing a responsive message to the input file to control access to the infrastructure.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF DRAWINGS

FIG. 1 is a block diagram illustrating an example of a computing environment in which infrastructure generation can be performed automatically using a dynamic directed acyclic graph (DAG) according to certain aspects of the present disclosure.

FIG. 2 is a flowchart illustrating an example of a process for automatically generating infrastructure using a dynamic DAG according to certain aspects of the present disclosure.

FIG. 3 is a block diagram of an example of an architecture of an infrastructure generation system that can be used to automatically generate infrastructure using a dynamic DAG according to certain aspects of the present disclosure.

FIG. 4 is a block diagram depicting an example of a computing system suitable for implementing aspects of the techniques and technologies presented herein.

### DETAILED DESCRIPTION

Certain aspects described herein for infrastructure automation using a dynamic directed acyclic graph (DAG) can address one or more of the foregoing issues. For example, automating infrastructure generating using the dynamic DAG can enable cloud computing systems to more easily scale in size and service compared with other cloud computing systems that do not automate infrastructure using the dynamic DAG. In some examples, the dynamic DAG may be or include a structured or ordered list of operations that, when traversed, can generate one or more computing resources of the infrastructure, for example in an interactive computing environment. The dynamic DAG may be dynamic such that the dynamic DAG can be generated on-the-fly or otherwise substantially contemporaneous with respect to receiving a request to generate the infrastructure. That is, while each iteration of the dynamic DAG may be stored for future reference or use in guiding infrastructure automation, the dynamic DAG may be generated, subject to a set of rules, each time a request for infrastructure is received. By generating the dynamic DAG on-the-fly, throughput for generating infrastructure in the cloud computing environment may be optimized and may be improved compared to other systems that do not generate the dynamic DAG on-the-fly.

Certain aspects described herein may relate to automating infrastructure generation using a dynamic DAG. Infrastructure may include or otherwise refer to computing resources that can be provided via a cloud computing environment to a user of the cloud computing environment. Some examples of computing resources can include computer storage, such as computer memory, computing capacity, such as processing power, or other suitable examples of computing resources that can be provided via a cloud computing environment. Automating infrastructure can involve generating, or otherwise configuring, the infrastructure without requiring manual input. For example, a user of the cloud computing environment may transmit an input file to a system configured to generate the dynamic DAG, and the system may automatically generate the dynamic DAG and may automatically facilitate generation of the infrastructure without additional input or manual intervention from an operator.

In some examples, the dynamic DAG may be generated based at least in part on a topology associated with computing resources that form the infrastructure. The computing resources may be indicated by an input file provided by the user of the cloud computing environment. For example, the user may generate an input file via a user interface provided by the cloud computing environment or the system that can generate the dynamic DAG, and the input file may include a request for generating or otherwise configuring the computing resources in the cloud computing environment. In a particular example, the input file may be or include an order for generating or configuring the computing resources on behalf of the user. The input file may include an indication of one computing resource or more than one resource. In examples in which the input file indicates more than one computing resource, the system may provide the input file to an intelligent parser to determine the topology. The topology may represent an order in which the computing resources may be generated or configured. For example, the intelligent parser may determine whether one or more dependencies exist between the computing resources, whether one or more restrictions exist between the computing resources, or may determine other boundary conditions for the computing resources. Based on the boundary conditions determined or otherwise identified by the intelligent parser, the system can determine whether the computing resources may be generated or configured (i) in parallel with respect to one another, (ii) in series with respect to one another, or (iii) in a particular combination of series and parallel with respect to one another. The intelligent parser may generate the topology of the computing resources based on the foregoing, and the topology can indicate whether the computing resources are to be generated or configured in parallel, in series, or in a particular combination thereof.

The topology may be provided to a DAG generator or other suitable component of the system that can generate the dynamic DAG. Generating the dynamic DAG may involve generating a configuration file representing the dynamic DAG in which the configuration file may indicate the topology of the computing resources. The system can execute the configuration file to traverse the dynamic DAG. Traversing the dynamic DAG may involve generating or configuring each computing resource indicated by the input file, or any subset thereof, according to the topology. That is, traversing the DAG can involve the system generating or configuring the computing resources in series, in parallel, or in a combination of series and parallel consistent with the topology. Traversing the DAG may involve performing a particular sequence of operations, which may have a particular order based on the topology, to generate or configure the computing resources to automatically generate the infrastructure.

The system can provide a responsive message in response to receiving the input file. For example, the system can transmit a responsive message to the user that provided, or caused to be provided, the input file to the system. The responsive message may control, such as provide or restrict, access of the user to the infrastructure. For example, in response to successfully generating the dynamic DAG and, in some examples, in response to successfully traversing the DAG to generate the infrastructure, the system may generate the responsive message to include a unique access key to only allow the user to access the infrastructure. The system can transmit the responsive message having the unique access key to the user to allow the user to access the infrastructure. In other examples, the system may generate or configure the infrastructure in such a way to prevent unauthorized access. That is, the infrastructure may be generated with access control that automatically prevents users that are not the user that provided the input file from accessing the infrastructure.

Certain aspects described herein, which can include automatic infrastructure generation using a dynamic DAG, can improve at least the technical field of cloud computing systems. For example, without using the automatic infrastructure generation described herein, other cloud computing environments may suffer from lack of scalability in resources and service. By using the intelligent parser to generate a topology of computing resources, the system can improve the scalability associated with the cloud computing environment at least by improving a throughput of computing resource generation, configuration, or a combination thereof. The intelligent parser can determine whether dependencies, restrictions, or other boundary conditions exist with respect to the computing resources, and the intelligent parser can generate or otherwise identify the topology of the computing resources based on the dependencies, restrictions, or other boundary conditions. By generating the topology, the system can determine an optimized sequence of operations, such as performing operations in a particular arrangement of series and parallel, for generating or configuring the computing resources that optimizes at least the throughput of infrastructure generation in the cloud computing environment.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Infrastructure Generation Using a Dynamic DAG

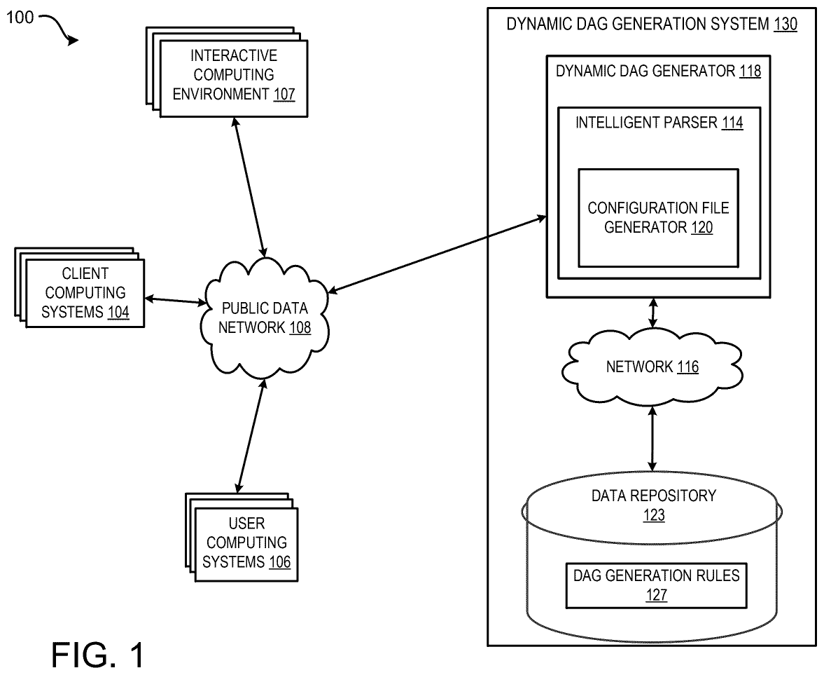

Referring now to the drawings, FIG. 1 is a block diagram illustrating an example of a computing environment 100 in which infrastructure generation can be performed automatically using a dynamic directed acyclic graph (DAG) to certain aspects of the present disclosure. FIG. 1 illustrates examples of hardware components of a dynamic DAG generation system 130 according to some aspects. The dynamic DAG generation system 130 can be a specialized computing system that may be used for processing large amounts of data, such as for automatically generating or configuring infrastructure, controlling access to the infrastructure, and so on, using a large number of computer processing cycles. The dynamic DAG generation system 130 can include a dynamic DAG generator 118 for generating a dynamic DAG based on an input file or a topology determined therefrom. In some examples, the dynamic DAG generation system 130 can include other suitable components, servers, subsystems, and the like.

The dynamic DAG generator 118 can include one or more processing devices that can execute program code, such as an intelligent parser 114, a configuration file generator 120, other suitable program code, or any combination thereof. The program code can be stored on a non-transitory computer-readable medium or other suitable medium. The dynamic DAG generator 118 can perform DAG generation or configuration operations or access control operations for validating or otherwise authenticating, for example using other suitable modules, services, models, components, etc. of the dynamic DAG generator 118, an access request of user computing systems 106 for accessing an interactive computing environment 107 that includes infrastructure.

In some examples, the intelligent parser 114 can determine a topology of computing resources indicated by an input file. The intelligent parser 114, or the dynamic DAG generator 118, may be communicatively coupled with a data repository 123 that can store rules such as DAG generation rules 127. The intelligent parser 114 can access the DAG generation rules 127 and can determine, generate, or otherwise identify the topology of the computing resources based on the DAG generation rules 127. The DAG generation rules 127 may include guidelines consumable by the dynamic DAG generator 118 or the intelligent parser 114. For example, the DAG generation rules 127 may include a set of if-then statements relating to how to generate or configure particular resources. In a particular example, the DAG generation rules 127 may have a rule that a first type of computing resource is dependent upon, or otherwise should be generated in series with respect to, a second type of computing resource. Additionally or alternatively, the DAG generation rules may have a rule that a third type of computing resource may be independently generated, such as generated in parallel, with respect to other types of computing resources. The DAG generation rules 127 may be manually provided to the data repository 123. In other examples, the DAG generation rules 127 may be automatically stored or updated in the data repository 123 in response to traversal of historically generated dynamic DAGs.

In examples in which the intelligent parser 114 is or includes an artificial intelligence model or other implementations of artificial intelligence, a training dataset can be stored in the data repository 123. In some examples, the training dataset can be used to train the artificial intelligence model, one or more machine-learning models, which may include a supervised machine-learning model, an unsupervised machine-learning model, a generative artificial intelligence model, and the like, included therein, etc. The artificial intelligence model, or other implementations of artificial intelligence, can be trained to generate the dynamic DAG, or the topology on which the dynamic DAG is based.

Network-attached storage units may store a variety of different types of data organized in a variety of different ways and from a variety of different sources. For example, the network-attached storage unit may include storage other than primary storage located within the dynamic DAG generator 118 that is directly accessible by processors located therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the dynamic DAG generation system 130 can communicate with various other computing systems. The other computing systems can include user computing systems 106, such as smartphones, personal computers, etc., client computing systems 104, and other suitable computing systems. For example, user computing systems 106 may transmit, such as in response to receiving input from the receiving entity, requests for accessing the interactive computing environment 107, requests for generating or configuring infrastructure (e.g., within the interactive computing environment 107), or other suitable requests to the client computing systems 104. The client computing systems 104 can send the requests to the dynamic DAG generation system 130, and the dynamic DAG generation system 130 may process the requests such as via the dynamic DAG generator 118, the intelligent parser 114, etc. In some examples, the requests may be transmitted directly from the user computing systems 106 to the dynamic DAG generation system 130. While FIG. 1 illustrates that the dynamic DAG generation system 130 and the client computing systems 104 are separate systems, the dynamic DAG generation system 130 and the client computing systems 104 can be one system. For example, the dynamic DAG generation system 130 can be a part of the client computing systems 104, or vice versa.

As illustrated in FIG. 1, the dynamic DAG generation system 130 may interact with the client computing systems 104, the user computing systems 106, or a combination thereof via one or more public data networks 108 to facilitate interactions between users of the user computing systems 106 and the interactive computing environment 107, which may be or include a cloud computing environment or system. For example, the dynamic DAG generation system 130 can facilitate the client computing systems 104 providing a user interface to the user computing system 106 for receiving various data, such as data that can be used to generate or cause generation or configuration of computing resources in the interactive computing environment 107. The dynamic DAG generation system 130 can transmit a computing resource topology, a dynamic DAG, configured computing resources, a responsive message, etc., to the client computing systems 104 for providing, challenging, or rejecting, etc. access of a user to the interactive computing environment 107, or infrastructure thereof. In some examples, the dynamic DAG generation system 130 can additionally communicate with third-party systems, such as external data systems, to receive risk assessment data, entity data, interaction data, evidence data, and other data relating to the user or the request for computing resources through the public data network 108. In some examples, the third-party systems can provide real-time, such as streamed, data to the dynamic DAG generation system 130.

Each client computing system 104 may include one or more devices such as individual servers or groups of servers operating in a distributed manner. A client computing system 104 can include any computing device or group of computing devices operated by a service provider or other suitable entity that can provide services via the interactive computing environment 107. The client computing system 104 can include one or more server devices. The one or more server devices can include or can otherwise access one or more non-transitory computer-readable media.

The client computing system 104 can further include one or more processing devices that can be capable of providing the interactive computing environment 107, such as a user interface, a cloud computing environment, etc., that can perform various operations. The interactive computing environment 107 can include executable instructions stored in one or more non-transitory computer-readable media. The instructions providing the interactive computing environment can configure one or more processing devices to perform the various operations. In some examples, the executable instructions for the interactive computing environment can include instructions that provide one or more graphical interfaces. The graphical interfaces can be used by a user computing system 106 to access various functions of the interactive computing environment 107. For instance, the interactive computing environment 107 may transmit data to and receive data, such as via the graphical interface, from a user computing system 106 to shift between different states of the interactive computing environment 107, where the different states enable one or more electronic interactions between the user computing system 106 and the client computing system 104 to be performed.

In some examples, the client computing system 104 may include other computing resources associated therewith (e.g., not shown in FIG. 1), such as server computers hosting and managing virtual machine instances for providing cloud computing services, server computers hosting and managing online storage resources for users, server computers for providing database services, and others. The interaction between the user computing system 106, the client computing system 104, and the dynamic DAG generation system 130, or any suitable sub-combination thereof may be performed through graphical user interfaces, such as the user interface, presented by the dynamic DAG generation system 130, the client computing system 104, other suitable computing systems of the computing environment 100, or any suitable combination thereof. The graphical user interfaces can be presented to the user computing system 106. Application programming interface (API) calls, web service calls, or other suitable techniques can be used to facilitate interaction between any suitable combination or sub-combination of the client computing system 104, the user computing system 106, and the dynamic DAG generation system 130.

A user computing system 106 can include any computing device or other communication device that can be operated by a user or entity such as the user that transmits the input file. In some examples, the user or entity may be or include a consumer or a customer. The user computing system 106 can include one or more computing devices such as laptops, smartphones, and other personal computing devices. A user computing system 106 can include executable instructions stored in one or more non-transitory computer-readable media. The user computing system 106 can additionally or alternatively include one or more processing devices configured to execute program code to perform various operations. In various examples, the user computing system 106 can allow a user to access certain online services or other suitable products, services, or computing resources from a client computing system 104, to engage in mobile interactions with the client computing system 104, to obtain controlled access to electronic content, such as the interactive computing environment 107 or infrastructure generated or configured thereon, hosted by the client computing system 104, etc.

In some examples, a user can use the user computing system 106 to engage in an electronic interaction with the client computing system 104 via the interactive computing environment 107. In additional examples, the user can use the user computing system 106 to submit, for example via the interactive computing environment 107 or via other suitable interactive computing environments, a request for infrastructure that can include computing resources. The dynamic DAG generation system 130 can receive a request, for example from the client computing system 104, to generate or configure infrastructure or computing resources and can use the DAG generation rules 127 to identify a topology of the computing resources, to generate the dynamic DAG, to generate a responsive message to facilitate access control of the user to the generated or configured infrastructure.

An electronic interaction between the user computing system 106 and the client computing system 104 can include, for example, the user computing system 106 being used to request products from the client computing system 104, and so on, and an interaction dispute may include an indication from the user computing system 106 that the target entity is requesting resources from the client computing system 104 due to an allegedly failed interaction. An electronic interaction between the user computing system 106 and the client computing system 104 can also include, for example, one or more queries for a set of sensitive or otherwise controlled data, accessing online financial services provided via the interactive computing environment 107, submitting an online credit card application or other digital application to the client computing system 104 via the interactive computing environment 107, operating an electronic tool, such as a content-modification feature, an application-processing feature, within the interactive computing environment 107, etc.

In some examples, an interactive computing environment 107 implemented through the client computing system 104 can be used to provide access to various online functions. As a simplified example, a user interface or other interactive computing environment 107 provided by the client computing system 104 can include electronic functions for requesting computing resources, online storage resources, network resources, database resources, real-world items or goods, or other types of resources.

A user computing system 106 can be used to request access to the interactive computing environment 107 provided by the client computing system 104, to submit an interaction dispute via the interactive computing environment 107 or other suitable computing environments, or the like. The client computing system 104 can submit a request, such as in response to the interaction dispute made by the user computing system 106, for infrastructure generation to the dynamic DAG generation system 130 and can selectively grant or deny access to the infrastructure or the interactive computing environment 107.

In a simplified example, the system illustrated in FIG. 1 can configure the dynamic DAG generator 118 to be used for determining a topology of requested computing resources, for generating a dynamic DAG, or other suitable operations. The dynamic DAG generator 118 can receive an input file via a user interface provided to the user computing system 106, provided by the client computing system 104 or received via other suitable computing systems. The dynamic DAG generator 118 can provide the input file to the intelligent parser 114 that can determine or identify a topology of the computing resources indicated by the input file. The topology can indicate an order of creating or configuring infrastructure that includes the computing resources. The intelligent parser 114 can provide the topology to the dynamic DAG generator 118 that can generate the dynamic DAG, for example via a configuration file generator 120. The configuration file generator 120 can receive the topology and can generate the dynamic DAG based at least in part on the topology. The dynamic DAG generation system 130 may traverse the dynamic DAG, may transmit the dynamic DAG to the client computing system 104 or the interactive computing environment 107 to be traversed, or may otherwise suitably facilitate traversal of the dynamic DAG to generate the infrastructure by generating the computing resources according to the topology. The dynamic DAG generation system 130 can provide access control or access permission for the generated infrastructure.

The access permission can include, for example, cryptographic keys used to generate valid access credentials or decryption keys used to decrypt access credentials. The client computing system 104 can also allocate resources to the receiving entity and provide a dedicated web address for the allocated resources to the user computing system 106, for example, by adding the user computing system 106 in the access permission. With the obtained access credentials or the dedicated web address, the user computing system 106 can establish a secure network connection to the interactive computing environment 107 hosted by the client computing system 104 and access the resources via invoking API calls, web service calls, HTTP requests, other suitable mechanisms or techniques, etc.

Each communication within the computing environment 100 may occur over one or more data networks, such as a public data network 108, a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the dynamic DAG generator 118 and the data repository 123, etc., may be instead implemented in a single device or system. Similarly and as discussed above, the dynamic DAG generation system 130 may be a part of the client computing system 104.

### Techniques for Infrastructure Generation Using a Dynamic Dag

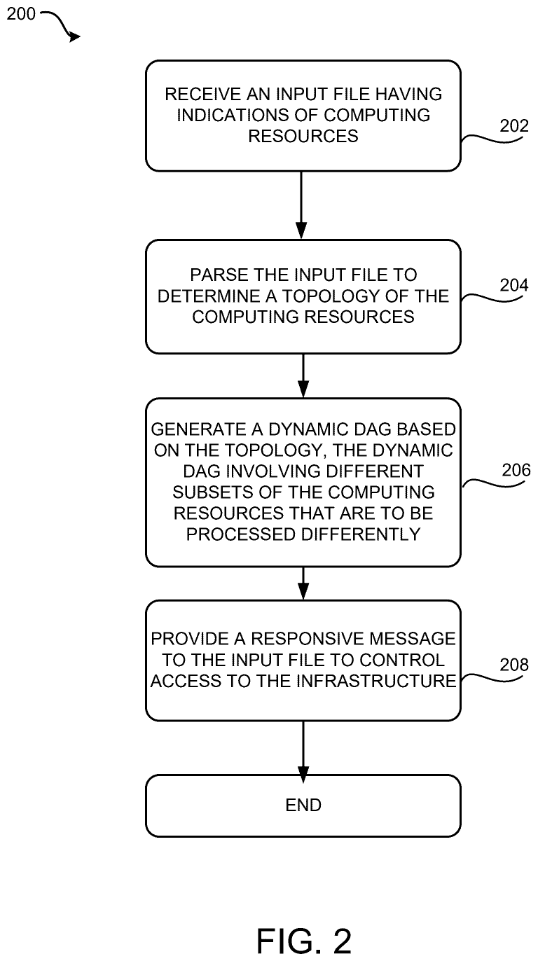

FIG. 2 is a flow chart illustrating an example of a process 200 for automatically generating infrastructure using a dynamic DAG according to certain aspects of the present disclosure. One or more computing devices, such as the dynamic DAG generation system 130, may implement operations illustrated in FIG. 2 by executing suitable program code such as the dynamic DAG generator 118, the intelligent parser 114, or other suitable program code. For illustrative purposes, the process 200 is described with reference to certain examples depicted in the figures. Other implementations, however, are possible.

At block 202, the process 200 involves receiving an input file from a user or a user computing device. The input file may include one or more indications of computing resources requested by the user to be generated, configured, or otherwise provided to the user. For example, the input file may be or include an order that indicates a request by a user for configuring or generating infrastructure within a cloud computing environment in which the infrastructure can be formed from the computing resources. In some examples, the computing resources can include storage, such as computer memory, processing power, such as one or more processing nodes, or other suitable computing resources that can be generated or configured for use by the user in the cloud computing environment.

At block 204, the process 200 involves parsing the input file to determine a topology of the computing resources. A topology of computing resources may be, may include, or may indicate an order in which the computing resources may be generated or configured. For example, a first computing resource may depend on, or otherwise require, a second computing resource such as by using the second computing resource to configure or generate the first computing resource. Other dependencies may be possible between the computing resources and may inform the topology of the computing resources.

In some examples, parsing the input file may involve using an intelligent parser 114 to parse the input file. The intelligent parser 114 may be included in a dynamic DAG generator 118, or other suitable component of the dynamic DAG generation system 130, and the intelligent parser 114 may include or otherwise have access to DAG generation rules 127. The DAG generation rules 127 may provide a framework for an optimized way in which to generate a dynamic DAG based on an input file. In some examples, the DAG generation rules 127 may be generated manually, automatically, or a combination thereof. For example, the DAG generation rules 127 may include at least partial instructions or rules provided via manual input. In other examples, the DAG generation rules 127 may be generated automatically, such as by the dynamic DAG generator 118 or other component of the dynamic DAG generation system 130, in response to historical attempts for generating infrastructure for a cloud computing environment. The automatically generated DAG generation rules may be tuned or otherwise suitably adjusted to enhance throughput of infrastructure generation using a dynamic DAG.

The intelligent parser 114 may determine whether the input file is in a compatible format. For example, the intelligent parser 114 may identify a format of the input file and compare the format against an expected format, against one or more compatible formats, or against a combination thereof. In accordance with determining that the input file is in a compatible format, the intelligent parser 114 can determine whether to proceed with generating the dynamic DAG based on available parameters associated with the input file. In other examples, and in accordance with determining that the input file is not in a compatible format, the intelligent parser 114 may cause an error to be output and may terminate processing of the input file. The available parameters may be or include parameters that can be used to generate one or more of the computing resources. For example, the available parameters may describe a particular service requested by the user, may describe operating systems or hardware requirements for the computing resources, may describe identification of the user, and other suitable available parameters. In some examples, and in accordance with the intelligent parser 114 determining not to proceed with generating the dynamic DAG based on the available parameters, the intelligent parser 114 can request, or can cause to be requested, additional parameters for generating the dynamic DAG and receiving the additional parameters prior to generating the dynamic DAG. An output of the intelligent parser 114 can include the topology of the computing resources, and the topology can represent an optimized throughput for generating or configuring the computing resources in the cloud computing environment.

At block 206, the process 200 involves generating the dynamic DAG based at least in part on the topology. The dynamic DAG generator 118 may receive the topology, or an indication thereof, from the intelligent parser 114, and the dynamic DAG generator 118 may generate the dynamic DAG. The dynamic DAG may include or indicate a first subset of computing resources and a second subset of computing resources that are indicated to be processed differently from the first subset of computing resources. The first subset of computing resources may be configured or generated in series with one another. The second subset of computing resources may be configured or generated in parallel with one another, in parallel with the first subset of computing resources, or a combination thereof. That is, the second subset of computing resources may include computing resources that can be independently configured or generated without regard to other computing resources in the cloud computing environment.

In some examples, the dynamic DAG can be traversed by the dynamic DAG generation system 130. In other examples, the dynamic DAG generation system 130 may transmit the dynamic DAG to a separate computing system, such as the client computing system 104, the interactive computing environment 107, etc., to cause the dynamic DAG to be traversed. Traversing the dynamic DAG can involve generating the infrastructure for the cloud computing environment by (i) executing a first set of operations to generate the first subset of the computing resources in series with one another and by (ii) executing a second set of operations to generate the second subset of the computing resources in parallel with one another or with the first subset of the computing resources.

At block 208, the process 200 involves providing a responsive message to the input file to control access to the infrastructure. The responsive message may include a message to the user that the infrastructure was generated successfully or encountered an error, depending on an outcome of traversing the dynamic DAG. The responsive message may be used to limit access to the infrastructure. For example, the responsive message can include a unique access key to allow only the user, or those indicated by the user, to access the infrastructure, use the infrastructure, or a combination thereof.

### Example of an Architecture for an Infrastructure Generation System

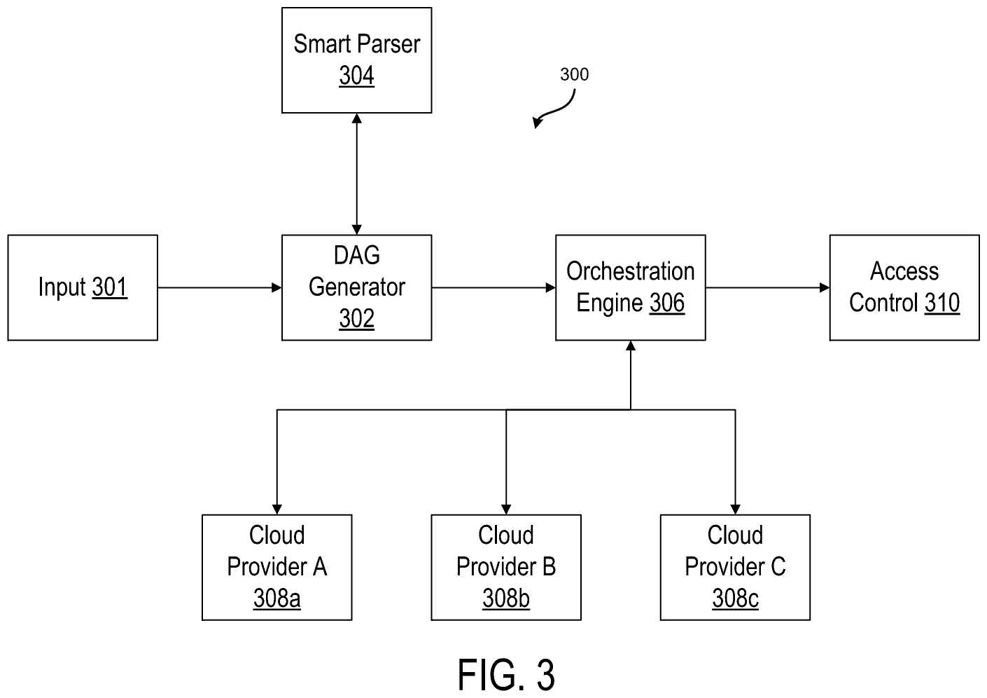

FIG. 3 is a block diagram of an example of an architecture 300 of an infrastructure generation system that can be used to automatically generate infrastructure using a dynamic DAG according to certain aspects of the present disclosure. As illustrated in FIG. 3, the architecture 300 can include a DAG generator 302 and an orchestration engine 306. The DAG generator 302 may be, or may be similar to, the dynamic DAG generator 118 as illustrated and described with respect to FIG. 1. The DAG generator 302 may receive input 301 that can be similar or identical to an input file as described above. For example, the input 301 can be or include an order, which may be generated or submitted by a user of a cloud computing system, that indicates a request for configuring or generating infrastructure in the cloud computing system.

The input 301 can be transmitted to the DAG generator 302, and the DAG generator 302 may transmit the input 301 to a Smart Parser 304. The Smart Parser 304 may be similar or identical to the intelligent parser 114, and the Smart Parser 304 may be used to parse the input 301 prior to performing processing based on the input 301. In some examples, the Smart Parser 304, or other suitable component of the DAG generator 302, may determine whether the input 301 is in a compatible format or an expected format. In examples in which the input 301 is not in a compatible format, the DAG generator 302 may terminate the order or processing based on the input 301, and the DAG generator 302 may output an error, a request for more information or a different format, or other suitable output. In examples in which the input 301 is in a compatible format, the Smart Parser 304 may proceed with parsing the input 301.

Parsing the input 301 may involve determining which computing resources are indicated by the requested infrastructure. Additionally or alternatively, parsing the input 301 may involve determining a topology of the computing resources. The topology may be or may indicate an optimized order in which the computing resources can be configured or generated, may be or may indicate relationships between the computing resources, etc. In some examples, the Smart Parser 304 may identify a first set of computing resources indicated by the input 301 and a second set of computing resources indicated by the input 301. The Smart Parser 304 may determine that the first set of computing resources are computing resources that are configured or generated in series with respect to one another. That is, the computing resources included in the first set of computing resources may have one or more dependencies on one another. For example, a first computing resource of the first set of computing resources may require functionality of a second computing resource of the first set of computing resources to be configured or generated. So, the Smart Parser 304 can identify the first set of computing resources as computing resources to be processed with a first set of operations that involves operations performed in series. Additionally or alternatively, the Smart Parser 304 may determine that the second set of computing resources are computing resources that can be configured or generated without considering other computing resources. That is, the computing resources included in the second set of computing resources may not have dependencies on other computing resources, whether in the first set of computing resources, the second set of computing resources, or other suitable sets of computing resources. So, the Smart Parser 304 can identify the second set of computing resources as computing resources to be processed with a second set of operations that involves operations performed in parallel with other operations.

An output of the Smart Parser 304 can include a topology or topological configuration file relating to the computing resources indicated by the input 301. The topology can be transmitted to the DAG generator 302 that can generate a dynamic DAG based on the topology. For example, the DAG generator 302 can generate the dynamic DAG to include indications that the first set of computing resources are to be generated or configured in series with one another and that the second set of computing resources are to be generated or configured in parallel with other computing resources. In some examples, the DAG generator 302 can generate a configuration file that can represent the dynamic DAG, and, upon execution of the configuration file, the dynamic DAG can be traversed or otherwise executed.

The dynamic DAG can be transmitted to the orchestration engine 306, which can cause the dynamic DAG to be traversed. In some examples, the orchestration engine 306 may be or operate under Kubernetes protocol or other suitable orchestration protocols. The orchestration engine 306 may execute the configuration file or otherwise traverse the dynamic DAG to generate or configure the computing resources. By traversing the dynamic DAG and generating or configuring the computing resources, the orchestration engine 306 may generate or configure infrastructure for a cloud computing environment. In some examples, the orchestration engine 306 may be integrated with or otherwise have access to one or more cloud providers that can each provide a cloud computing environment. For example, the orchestration engine 306 may be integrated into or otherwise have access to cloud provider A 308a, cloud provider B 308b, cloud provider C 308c, other suitable cloud providers, or any combination thereof. By traversing the dynamic DAG, the orchestration engine 306 may cause infrastructure in a particular cloud computing environment provided by a particular cloud provider, or a combination of multiple cloud providers, to be generated or configured.

Upon generating or configuring the infrastructure, the orchestration engine 306 may provide access control 310. The access control 310 may include controlling access to the infrastructure, or to the cloud computing environment in which the infrastructure was generated or configured. For example, the access control 310 can include a unique key that can enable specific entities, such as the user that provided the input 301, to access or interact with the infrastructure while restricting or otherwise preventing other entities from accessing or interacting with the infrastructure.

### Example of Computing System

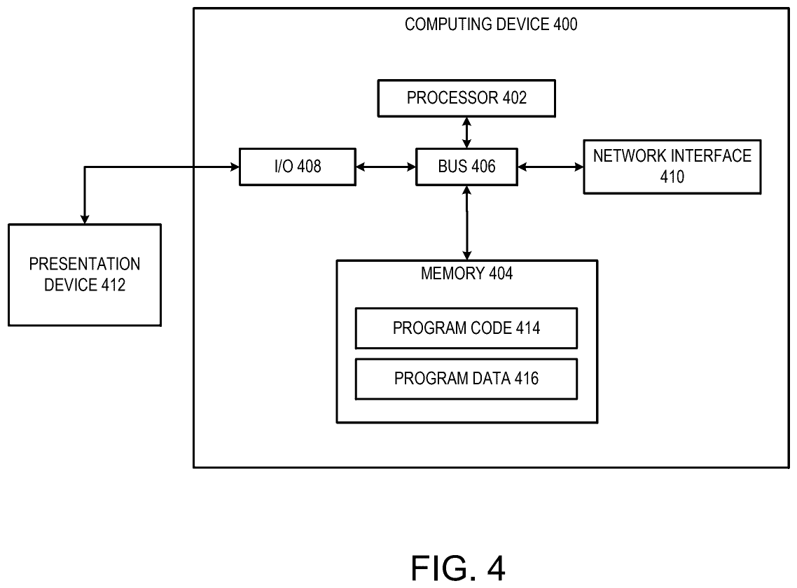

Any suitable computing system or group of computing systems can be used to perform the operations for the artificial intelligence techniques described herein. For example, FIG. 4 is a block diagram illustrating an example of a computing device 400, which can be used to implement the dynamic DAG generator 118, the intelligent parser 114, the dynamic DAG generation system 130, or other suitable components of the computing environment 100. The computing device 400 can include various devices for communicating with other devices in the computing environment 100, for example as described with respect to FIG. 1. The computing device 400 can include various devices for performing one or more data consolidation or validation operations, artificial intelligence operations, infrastructure generation or configuration or other suitable operations, described above with respect to FIGS. 1-3.

The computing device 400 can include a processor 402 that is communicatively coupled with a memory 404. The processor 402 can execute computer-executable program code stored in the memory 404, can access information stored in the memory 404, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 402 can include a microprocessor, an application-specific integrated circuit (ASIC), a field-programmable gate array (FPGA), or any other suitable processing device. The processor 402 can include any suitable number of processing devices, including one. The processor 402 can include or communicate with a memory 404. The memory 404 can store program code that, when executed by the processor 402, causes the processor 402 to perform operations such as one or more of the operations described herein.

The memory 404 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 400 may also include a number of external or internal devices such as input or output devices. For example, the computing device 400 is illustrated with an input/output interface 408 that can receive input from input devices or provide output to output devices. A bus 406 can also be included in the computing device 400. The bus 406 can communicatively couple one or more components of the computing device 400.

The computing device 400 can execute program code 414 that can include the intelligent parser 114, the dynamic DAG generator 118, or any other suitable computer model, computer module, computer service, or the like. The program code 414 for the intelligent parser 114, the dynamic DAG generator 118, or the like may be resident in any suitable computer-readable medium and may be executed on any suitable processing device. For example, as depicted in FIG. 4, the program code 414 for the intelligent parser 114, the dynamic DAG generator 118, etc. can reside in, or may otherwise be included in, the memory 404 at the computing device 400 along with the program data 416 associated with the program code 414. Executing the intelligent parser 114, the dynamic DAG generator 118, etc. can configure the processor 402 to perform one or more of the operations described herein.

In some aspects, the computing device 400 can include one or more output devices. One example of an output device can be the network interface device 410 illustrated in FIG. 4. A network interface device 410 can include any device or group of devices suitable for establishing a wired or wireless data connection to one or more data networks described herein. Non-limiting examples of the network interface device 410 can include an Ethernet network adapter, a modem, etc.

Another example of an output device can include the presentation device 412 depicted in FIG. 4. A presentation device 412 can include any device or group of devices suitable for providing visual, auditory, or other suitable sensory output. Non-limiting examples of the presentation device 412 can include a touchscreen, a monitor, a speaker, a separate mobile computing device, etc. In some aspects, the presentation device 412 can include a remote client-computing device that can communicate with the computing device 400 using one or more data networks described herein. In other aspects, the presentation device 412 can be optional.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A system comprising:
a processor; and
a non-transitory computer-readable medium comprising instructions that are executable by the processor to cause the processor to perform operations comprising:
receiving an input file comprising a set of indications of computing resources for a cloud computing environment;
parsing the input file to determine a topology of the computing resources based on the set of indications; and
generating, based on the topology, a dynamic directed acyclic graph (DAG) for generating infrastructure for the cloud computing environment based on the computing resources, wherein the operation of generating the dynamic DAG comprises:
determining a first subset of the computing resources and a second subset of the computing resources, and
configuring the first subset of the computing resources to be processed differently from the second subset of the computing resources.

2. The system of claim 1, wherein the operations further comprise traversing the dynamic DAG to generate the infrastructure by (i) executing a first set of operations to generate the first subset of the computing resources and (ii) executing a second set of operations to generate the second subset of the computing resources, and wherein the first set of operations are different from the second set of operations.

3. The system of claim 2, wherein the operations further comprise providing a responsive message to the input file to control access to the infrastructure, wherein the operation of providing the responsive message comprises outputting the infrastructure with a unique access key to allow an entity that provided the input file to access the infrastructure.

4. The system of claim 1, wherein the operation of parsing the input file comprises:
determining whether the input file is in a compatible format; and
performing one of the following:
in accordance with determining that the input file is in the compatible format, determining whether to proceed with generating the dynamic DAG based on available parameters associated with the input file; or
in accordance with determining that the input file is not in the compatible format, outputting an error and terminating processing of the input file.

5. The system of claim 4, wherein, in accordance with determining not to proceed with generating the dynamic DAG based on the available parameters, the operation of determining whether to proceed with generating the dynamic DAG comprises requesting additional parameters for generating the dynamic DAG and receiving the additional parameters prior to generating the dynamic DAG.

6. The system of claim 1, wherein the operation of configuring the first subset of the computing resources to be processed differently from the second subset of the computing resources comprises:
configuring the first subset of the computing resources to be processed using a first process; and
configuring the second subset of the computing resources to be processed using a second process that is different from the first process.

7. The system of claim 6, wherein the first process involves processing the first subset of the computing resources in parallel with one another, and wherein the second process involves processing the second subset of the computing resources in series with one another.

8. A method comprising:
receiving an input file comprising a set of indications of computing resources for a cloud computing environment;
parsing the input file to determine a topology of the computing resources based on the set of indications; and
generating, based on the topology, a dynamic directed acyclic graph (DAG) for generating infrastructure for the cloud computing environment based on the computing resources, wherein generating the dynamic DAG comprises:
determining a first subset of the computing resources and a second subset of the computing resources, and
configuring the first subset of the computing resources to be processed differently from the second subset of the computing resources.

9. The method of claim 8, further comprising traversing the dynamic DAG to generate the infrastructure by (i) executing a first set of operations to generate the first subset of the computing resources and (ii) executing a second set of operations to generate the second subset of the computing resources, and wherein the first set of operations are different from the second set of operations.

10. The method of claim 9, further comprising providing a responsive message to the input file that controls access to the infrastructure, wherein providing the responsive message comprises outputting the infrastructure with a unique access key to allow an entity that provided the input file to access the infrastructure.

11. The method of claim 8, wherein parsing the input file comprises:
determining whether the input file is in a compatible format; and
performing one of the following:
in accordance with determining that the input file is in the compatible format, determining whether to proceed with generating the dynamic DAG based on available parameters associated with the input file; or
in accordance with determining that the input file is not in the compatible format, outputting an error and terminating processing of the input file.

12. The method of claim 11, wherein, in accordance with determining not to proceed with generating the dynamic DAG based on the available parameters, determining whether to proceed with generating the dynamic DAG comprises requesting additional parameters for generating the dynamic DAG and receiving the additional parameters prior to generating the dynamic DAG.

13. The method of claim 8, wherein configuring the first subset of the computing resources to be processed differently from the second subset of the computing resources comprises:
configuring the first subset of the computing resources to be processed using a first process; and
configuring the second subset of the computing resources to be processed using a second process that is different from the first process.

14. The method of claim 13, wherein the first process involves processing the first subset of the computing resources in parallel with one another, and wherein the second process involves processing the second subset of the computing resources in series with one another.

15. A non-transitory computer-readable medium comprising instructions that are executable by a processing device for causing the processing device to perform operations comprising:
receiving an input file comprising a set of indications of computing resources for a cloud computing environment;
parsing the input file to determine a topology of the computing resources based on the set of indications; and
generating, based on the topology, a dynamic directed acyclic graph (DAG) for generating infrastructure for the cloud computing environment based on the computing resources, wherein the operation of generating the dynamic DAG comprises:
determining a first subset of the computing resources and a second subset of the computing resources, and
configuring the first subset of the computing resources to be processed differently from the second subset of the computing resources.

16. The non-transitory computer-readable medium of claim 15, wherein the operations further comprise traversing the dynamic DAG to generate the infrastructure by (i) executing a first set of operations to generate the first subset of the computing resources and (ii) executing a second set of operations to generate the second subset of the computing resources, and wherein the first set of operations are different from the second set of operations.

17. The non-transitory computer-readable medium of claim 16, wherein the operations further comprise providing a responsive message to the input file to control access to the infrastructure, wherein the operation of providing the responsive message comprises outputting the infrastructure with a unique access key to allow an entity that provided the input file to access the infrastructure.

18. The non-transitory computer-readable medium of claim 15, wherein the operation of parsing the input file comprises:
determining whether the input file is in a compatible format; and
performing one of the following:
in accordance with determining that the input file is in the compatible format, determining whether to proceed with generating the dynamic DAG based on available parameters associated with the input file; or
in accordance with determining that the input file is not in the compatible format, outputting an error and terminating processing of the input file.

19. The non-transitory computer-readable medium of claim 18, wherein, in accordance with determining not to proceed with generating the dynamic DAG based on the available parameters, the operation of determining whether to proceed with generating the dynamic DAG comprises requesting additional parameters for generating the dynamic DAG and receiving the additional parameters prior to generating the dynamic DAG.

20. The non-transitory computer-readable medium of claim 15, wherein the operation of configuring the first subset of the computing resources to be processed differently from the second subset of the computing resources comprises:
configuring the first subset of the computing resources to be processed using a first process that involves processing the first subset of the computing resources in parallel with one another; and
configuring the second subset of the computing resources to be processed using a second process that is different from the first process, wherein the second process involves processing the second subset of the computing resources in series with one another.
